(19) United States
(12) Patent Application Publication
(10) Pub. No.: US 2002/0188846 A1
(43) Pub. Date: Dec. 12, 2002

(54) OSS signature scheme

(76) Inventor: Yaakov (Jordan) Levy, Maaleh Adumim (IL)

Correspondence Address: Gerald T. Shekleton, Esq., Welsh & Katz, Ltd., 22nd Floor, 120 S. Riverside Plaza, Chicago, IL, 60606, US

(21) Appl. No.: 10/062,001

(22) Filed: Feb. 1, 2002

(30) Foreign Application Priority Data
May 3, 2001 (IL) 142962

(51) Int. Cl. H04L 9/00

(52) U.S. Cl. 713/170

(57) ABSTRACT

A method for digitally signing a message is described. The method includes providing a message digest (Mₓ, M_{z}), providing a modulus N, providing a number V in a ring Z_{N}, wherein for another number S in the ring Z_{N}, V·S²=1 in Z_{N}, solving the equation (Mₓ+X)²−V·y²=4·(M_{z}+z) in Z_{N} to produce x, y, and z, and assigning SIG as the signature of M_{X}, M_{Z}), wherein SIG includes (x,y). Related methods and apparatus are also described.

### FIELD OF THE INVENTION

The present invention relates to digital signature schemes in general, and in particular to the OSS signature scheme.

### BACKGROUND OF THE INVENTION

Many signature schemes are based on the difficulty of solving a hard mathematical problem. With special knowledge, typically termed in the art knowledge of a “trapdoor”, the mathematical problem can be solved easily. Easy solution allows one who knows the trap door to easily sign a document. The difficulty of anyone else, not knowing the trap door, solving the hard problem and thus forging the signature makes the signature reliable.

The following references may assist in understanding the background of the present invention, and are referred to below according the their respective numbers:

[1] L. Adleman, D. Estes, and K. McCurley, “Solving Bivariate Quadratic Congruences in Random Polynomial Time,” Mathematics of Computation, v. 48, n. 177, January 1987, pp. 17-28.

[2] D. Estes, L. Adleman, K. Kompella, K. McCurley, and G. Miller, “Breaking the Ong-Schnorr-Shamir Signature Scheme for Quadratic Number Fields,” Advances in Cryptology: Proceedings of CRYPTO '85, Springer-Verlag, 1986, pp. 3-13.

[3] A. Fiat and A. Shamir, “How to Prove Yourself: Practical Solutions to Identification and Signature Problems,” Advances in Cryptology: Proceedings of CRYPTO '86, Springer-Verlag, 1987, pp. 186-194.

[4] D. Naccache, “Can O.S.S. be Repaired? Proposal for a New Practical Signature Scheme,” Advances in Cryptology: Proceedings of EUROCRYPT '93, Springer-Verlag, 1994, pp. 233-239.

[5] National Institute of Standards and Technology, NIST FIPS PUB 186, “Digital Signature Standard,” U.S. Department of Commerce, May 1994.

[6] H. Ong, C. P. Schnorr, and A. Shamir, “An Efficient Signature Scheme Based on Quadratic Equations,” Proceedings of the 16th Annual Symposium on the Theory of Computing, 1984, pp. 208-216.

[7] H. Ong, C. P. Schnorr, and A. Shamir, “Efficient Signature Schemes Based on Polynomial Equations,” Advances in Cryptology: Proceedings of CRYPTO '84, Springer-Verlag, 1985, pp. 37-46.

[8] J. Pollard and C. Schnorr, “An Efficient Solution of the Congruence x²+k·y²=m mod n,” IEEE Transactions on Information Theory, v. IT-33, n. 5, September 1987, pp. 702-709.

[9] M. O. Rabin, “Digital Signatures and Public-Key Functions as Intractable as Factorization,” MIT Laboratory for Computer Science, Technical Report, MLT/LCS/TR-212, January 1979.

[10] R. L. Rivest, A. Shamir, and L. M. Adleman, “A Method for Obtaining Digital Signatures and Public-Key Cryptosystems,” Communications of the ACM, v. 21, n. 2, February 1978, pp. 120-126.

[11] U.S. Pat. No. 4,405,829 to Rivest et al.

[12] U.S. Pat. No. 4,748,668 to Shamir et al.

The following mathematical and related conventions are used throughout the present specification and claims.

1. Greek symbols α, β, γ are used to denote variables that may be chosen “randomly” (within certain specified constraints), and upper case letters (A, B, C, . . . ) to denote variables that are either directly or indirectly derived from these random variables.

2. N is used to denote a composite modulus suitable for RSA; that is, the product of two large prime, secret factors. All operations will be in one of the three rings of integers: Z, Z_{N}, and Z_{β} (where β is an integer we will choose). With each step, we will clearly indicate in which ring the step is being performed. Additionally, to avoid confusion, we will use the notation x⁻¹ to denote the inverse of x in finite ring Z_{N} or Z_{β} (and y·x⁻¹ to denote y divided by x in Z_{N} or Z_{β}), while we will use the notation y/x to denote integer division (with truncation as needed) in Z.

RSA refers to the well-known RSA signature scheme described, for example, in references [10] and [11].

Since, as is well known, multiplication does not associate with integer division, that is, x·(y/z) may not equal (x·y)/z, parentheses will be used as necessary to avoid ambiguity. For example:

3·(5/2)=6≠7=(3·5)/2

The OSS signature scheme, was proposed over 15 years ago in reference [6]. The OSS signature scheme was based on the supposed difficulty of finding solutions to quadratic bivariate equations in Z_{N}, with the trapdoor allowing a legitimate signer to sign being structural knowledge of the coefficients that allowed factoring a constant term of the polynomial into linear expressions. For example, solving for x, y in the equation termed herein “the OSS equation”:

x²−V·y²−m=0 in Z_{N}

can be done with knowledge of S such that S⁻²=V in Z_{N}:

(x+y·S⁻¹)·(x−y·S⁻¹)=m

Decomposing the constant m into factors α and m·α⁻¹ for some randomly chosen invertible α in Z_{N}, and solving the system of simultaneous linear equations:

x+y·S⁻¹=m·α⁻¹x−y·S⁻¹=α

yields the solution:

x=2⁻¹·(m·α⁻¹+α)y=2⁻¹·S·(m·α⁻¹−α)

Throughout the present specification and claims, the notation (a, b) is used to denote an ordered pair comprising a and b. The above problem is transformed to a signature scheme by allowing (V, N) to be the public key, S to be the private key, m to be the message digest to be signed, and (x, y) to be the signature.

The OSS signature scheme was broken with the development of a random polynomial time method for solving bivariate quadratic equations in general, without the trapdoor knowledge; see references [1], [2], and [8]. This solution method is much less efficient than the solution method using the trapdoor, but still sufficiently tractable to render the OSS scheme unsecure for most digital signature purposes.

The appeal of OSS, then and now, is that it requires a very small number of multiple precision multiplicative operations to sign, in contrast to most other secure public key signature methods based on either factoring or discrete logarithms. Some schemes, such as DSA, described in reference [5], also achieve this result when precomputation is allowed; that is, when not counting the work done prior to knowledge of the message to be signed. However, precomputation is not always operationally feasible.

Many public key signature schemes, such as low exponent RSA, described in references [10] and [11], or Rabin, described in reference [9], can be very efficient for the verifier, but not for the signer. However, in certain contexts, particularly digital signature using a smart card, it is appreciated that the ability to sign efficiently is more important than the ability to verify efficiently.

For the reason of efficiency, there have been many attempts to repair OSS with variants of various types, primarily retaining the flavor of the original OSS while introducing constructs or changing the domain so as to obstruct the attack on the original OSS. All such proposals have either been shown to be insecure, do not retain the appealing property of using a very limited number of multiplicative operations, or are of too recent vintage to be considered secure yet.

For example, the original proposers of OSS generalized the problem by extending the domain from which the signature variables and coefficients were to be chosen from the rational integers to the quadratic integers, as described in reference [7], hoping that the attack method on the original form could not be applied in the new case. However, it was shown, as described in reference [2], that an instance of the extended problem may be polynomially transformed to the simpler domain, and the transformed problem can then be solved with the original attack. Thus, the quadratic integers variation does not overcome the weakness of the original OSS.

Naccache, as described in reference [4], proposes two alternate approaches to securing OSS, taking advantage of the fact that the attacker has no control over the “structure” of the x and y returned by the OSS attack method. In the first of these approaches, the public key V is replaced by a non-polynomial function of x, thereby obstructing the attack method, which necessarily generates the x and y in parallel. He presents a practical example of a non-polynomial function in which the private key holder can solve the resultant equation. While this construct is sound and fairly efficient, it is very similar to the approach of the Fiat-Shamir signature scheme, described in references [3] and [12], in which a large number of “binary proofs” are effectively “aggregated”, and the number of multiple precision multiplicative operations needed (as well as the number of keys needed) is proportional to the logarithm of the size of a secure search space. Thus, the first Naccache approach is not as efficient as the original OSS.

In the second Naccache approach, Naccache proposes requiring the choosing of x and y in such a way that the random parameter upon which x and y are based must have a required structural form. It will be apparent to persons skilled in the art that the difficulty of constructing such a scheme is that the random parameter must be kept a secret in order to avoid compromising the private key. He presents an intuitive argument of how it might be possible to construct such a scheme, which would be more like the original OSS in terms of having a single key and would perhaps require a small number of multiplicative operations. Although this approach looks promising, the inventor of the present invention is not aware of any convincing results yet in this direction.

There is thus a need for an effective and efficient approach to securing OSS.

The disclosures of all references mentioned above and throughout the present specification are hereby incorporated herein by reference.

### SUMMARY OF THE INVENTION

The present invention seeks to provide an improved variant of the OSS signature scheme.

The present invention, in a preferred embodiment thereof, uses yet another approach to securing OSS, by generalizing the original OSS equation to include approximations. Proof of the security of the preferred approach is not currently available, but the approach appears resistant to the types of attacks on OSS and OSS variants used until now. It is speculated that a different attack, from a somewhat different mathematical domain, would be needed to disprove its security.

There is thus provided in accordance with a preferred embodiment of the present invention a method for digitally signing a message, the method including providing a message digest (M_{X}, M_{Z}), providing a modulus N, providing a number V in the ring Z_{N}, wherein for another number S in the ring Z_{N}, V·S²=1 in Z_{N}, solving the equation (Mₓ+x)²−V·y²=4·(M_{z}+z) in Z_{N} to produce x, y, and z, and assigning SIG as the signature of (M_{X}, M_{Z}), wherein SIG includes (x,y).

Further in accordance with a preferred embodiment of the present invention SIG includes (x,y,z).

Still further in accordance with a preferred embodiment of the present invention the solving includes the following: a) choosing α and β in Z such that 0≦α<β<2^{k-1} and gcd(α,β)=1 in Z; b) choosing γ in Z such that 2^{n-k-1}≦γ<2^{n-k} and β|(α·N+γ) in Z; c) setting R equal to (α·N+γ)/β in Z; d) setting T equal to −(M_{z}·R+Mₓ+R⁻¹) in Z_{N}; e) if β=1 or T<8·γ (in Z), setting U and W equal to 0 and continuing with step k; f) setting D equal α⁻¹ in Z_{β}; b) setting A equal to N/β in Z; h) setting B equal to (T−8·γ)/A in Z; i) setting U equal to B·D in Z_{β}; j) setting W equal to U·R in Z_{N}; k) setting C (T−W)/γ in Z; 1) setting z equal to U+β·C in Z_{N}; m) setting x equal to T−z·R in Z_{N}; and n) setting y equal to S·(x+Mₓ+2·R⁻¹) in Z_{N}, thereby producing x, y, and z.

Additionally in accordance with a preferred embodiment of the present invention the method also includes providing a trusted computation device and a non-trusted computation device, and step d) includes performing a computation in the non-trusted computation device.

Moreover in accordance with a preferred embodiment of the present invention the computation in the non-trusted computation device includes a computation of R⁻¹.

Further in accordance with a preferred embodiment of the present invention the computation in the non-trusted computation device is protected from tampering by performing a blinding method in the trusted computation device.

Still further in accordance with a preferred embodiment of the present invention the method also includes verifying a result of the computation in the non-trusted computation device.

Additionally in accordance with a preferred embodiment of the present invention step a) includes screening α and β.

Moreover in accordance with a preferred embodiment of the present invention the screening includes reducing α and β modulo 210.

Further in accordance with a preferred embodiment of the present invention the reducing α and β modulo 210 includes computing gcd(210, (α mod 210), (β mod 210) to produce a result, and rejecting α and β and choosing another α and β if the result is not equal to 1.

Still further in accordance with a preferred embodiment of the present invention the solving includes the following: a) setting α equal to 0; b) setting β=1; c) choosing γ such that 2^{n-k-1}≦γ<2^{n-k}; d) setting T equal to −(M_{z}·γ+Mₓ+γ⁻¹) in Z_{N}; e) setting z equal to T/γ in Z; f) setting x equal to T−z·γ in Z_{N}; and g) setting y equal to S·(x+Mₓ+2·γ⁻¹) in Z_{N}, thereby producing x, y, and z.

Additionally in accordance with a preferred embodiment of the present invention the method also includes providing a trusted computation device and a non-trusted computation device, wherein step d) includes performing a computation in the non-trusted computation device.

Further in accordance with a preferred embodiment of the present invention the computation in the non-trusted computation device includes a computation of γ⁻¹.

Still further in accordance with a preferred embodiment of the present invention the computation in the non-trusted computation device is protected from tampering by performing a blinding method in the trusted computation device.

Additionally in accordance with a preferred embodiment of the present invention the method also includes verifying a result of the computation in the non-trusted computation device.

There is also provided in accordance with another preferred embodiment of the present invention a message signer for digitally signing a message based on a message digest (M_{X}, M_{Z}), a modulus N, and a number V in the ring Z_{N}, wherein for another number S in the ring Z_{N}, V·S²=1 in Z_{N}, the message signer including a solver for solving the equation (Mₓ+x)²−V·y²=4·(M_{z}+z) in Z_{N} to produce x, y, and z, and a signature assignor for assigning SIG as the signature of (M_{X}, M_{Z}), wherein SIG includes (x,y).

### BRIEF DESCRIPTION OF THE DRAWINGS

The present invention will be understood and appreciated more fully from the following detailed description, taken in conjunction with the drawings in which:

FIG. 1 is a simplified block diagram illustration of a method for signing a message digest in accordance with a preferred embodiment of the present invention;

FIGS. 2A and 2B, taken together, comprise a simplified flowchart illustration of a preferred implementation of step 100 of FIG. 1;

FIG. 3 comprises a simplified flowchart illustration of an alternative preferred implementation of step 100 of FIG. 1; and

FIG. 4 is a simplified block diagram illustration of an apparatus suitable for implementing the method of FIG. 1.

### DETAILED DESCRIPTION OF A PREFERRED EMBODIMENT

In a preferred embodiment of the present invention, the OSS problem is generalized by adding a third variable z, with restricted range, to the right hand side of the OSS equation described above, thus effectively changing the OSS equation to an approximate equality. The system based on the approximate equality is also termed herein “Fuzzy OSS”. At the same time a compensation is made by restricting the range of variable x, so that the number of solutions for any given key and message digest remains approximately the same as in the original problem, i.e., it remains approximately O(N).

Note that the approach of the preferred embodiment differs from the second Naccache approach presented above. In this case it is the value of x itself which is explicitly being restricted, rather than the relation between x and its generating random parameter being implicitly restricted, as in the second Naccache approach. The modified, or Fuzzy OSS, problem then appears as follows:

Find a solution (x, y, z), in Z_{N}×Z_{N}×Z_{N}, for the equation:

(Mₓ+x)²−V·y²=4·(M_{z}+z) in Z_{N}

termed herein the Fuzzy OSS equation, where:

N is a given “RSA-type” modulus of length n bits (i.e., 2ⁿ⁻¹≦N<2ⁿ) and secret factorization;

x and z satisfy 0≦x<2^{n-k} and 0≦z<2^{k+3} for a given k, 0<<2·k≦n; and

Mₓ, M_{z}, and V are given.

Note that if k is allowed to approach 0 (as opposed to the requirement given above), this problem becomes computationally equivalent to the original OSS problem.

A more general statement concerning x and z may be given as follows:

0≦x<2^{u}

0≦z<2^{v}

The requirements for u and v can be stated more generally as follows:

The sum u+v should be close to n. If it is considerably smaller than n, the solution methods given herein will not succeed most of the time. To the extent that it is greater than n, the problem will become easier for an attacker to solve (i.e., to “forge”, even without knowing the secret).

The value of u should preferably be greater than or equal to n/2. If u is less than n/2, then the problem is still solvable, but the solution methods given herein need to be modified slightly, and some generality of solution is lost (with possible loss of security).

The value of v should not be “close” to either 0 or n. If v is close to 0, the problem may be transformed to an instance of the original OSS problem (which is not secure). If v is close to n, the problem is trivial to solve.

Given the above guidelines, the choice of u=n−k and v=k+3 (with k≦n/2, but k not close to 0) was chosen to allow the solution, described below, to always find a solution, without ever needing to retry. The addition of the small “offset” constant 3 in the exponent (or any such small offset) does not affect the essential difficulty of the problem.

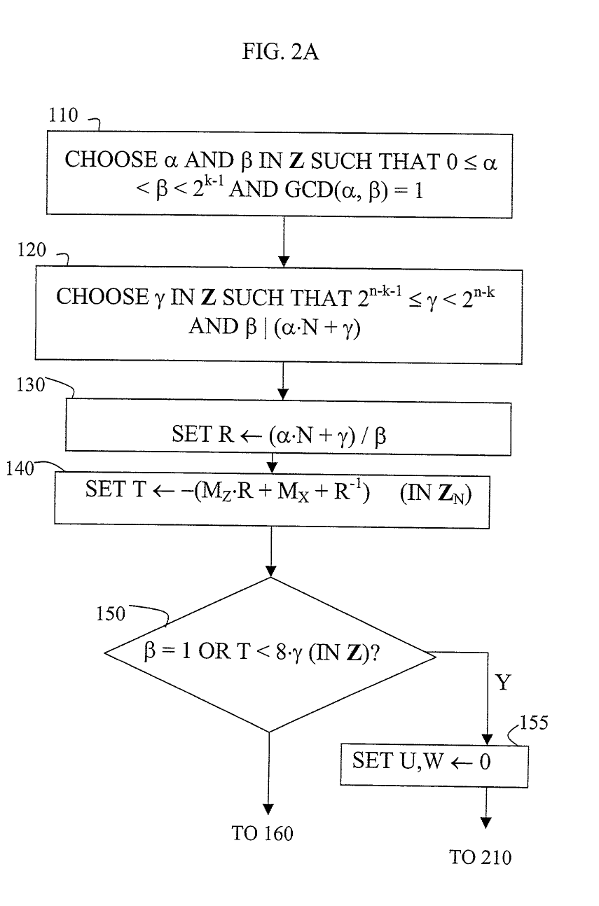

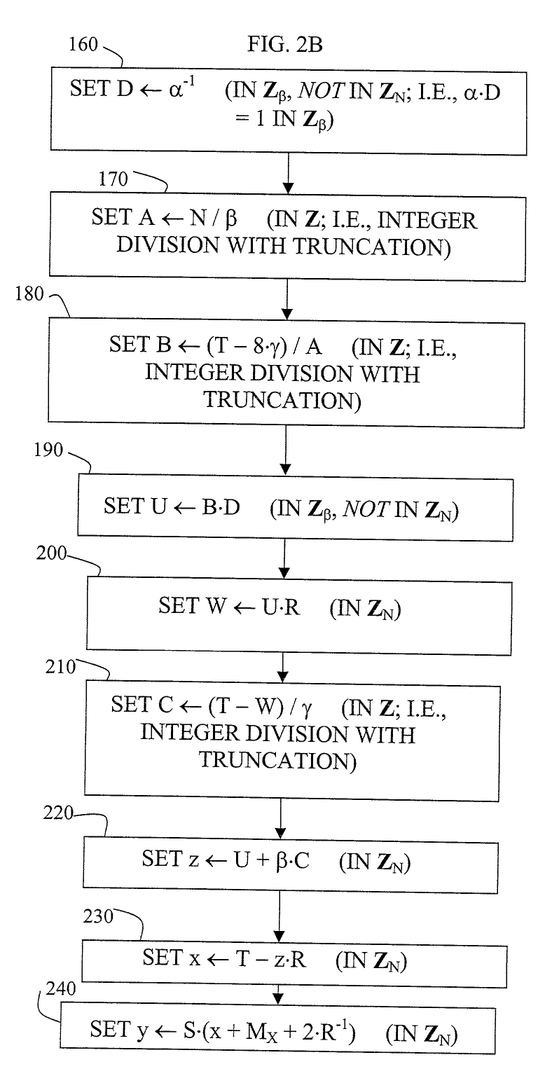

The Fuzzy OSS problem can be made into a signature scheme by allowing (V, N) to be the public key, S to be the private key (where V·S²=1 in Z_{N}), and (Mₓ, M_{z}) to be the message digest to be signed. The signature of (Mₓ, M_{z}) is the triple (x, y, z); however, since z can be easily and deterministically computed from (x, y) without knowledge of the private key, it does not need to be sent or even calculated by the signer. In the solution method presented below, z will be computed because its value is needed as an intermediate value in the calculation of x and y. The discussion below, with reference to FIG. 2, will show how knowledge of the private key S allows a relatively efficient solution to this problem.

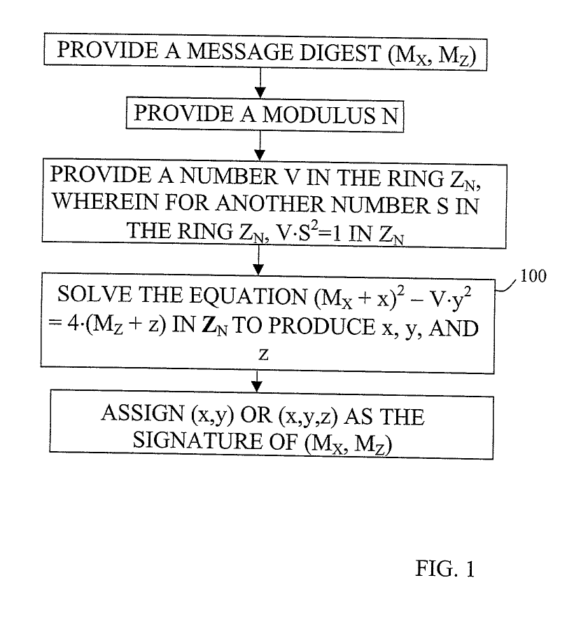

Reference is now made to FIG. 1 which is a simplified block diagram illustration of a method for signing a message digest in accordance with a preferred embodiment of the present invention. The method of FIG. 1 is self-explanatory with reference to the above discussion, except as follows. Preferably, in step 100, a method is provided to solve the Fuzzy OSS equation, based preferably on secret knowledge of a key S as described above.

Reference is now made to FIGS. 2A and 2B, which, taken together, comprise a simplified flowchart illustration of a preferred implementation of step 100 of FIG. 1.

As mentioned above, operations described below will be performed in three different rings: Z, Z_{N}, and Z_{β} (where β will be chosen). For each step, the ring in which to perform the operation will be noted.

The method of FIGS. 2A and 2B preferably comprises the following steps:

Step 110: Choose α and β in Z such that 0≦α<2ₖ₋₁ and gcd(α, β)=1 (in Z)

Step 120: Choose γ in Z such that 2^{n-k-1}≦γ<2^{n-k} and β|(α·N+γ) (in Z)

Step 130: Set R←(α·N+γ)/β (in Z; i.e., integer division)

Step 140: Set T←(M_{z}·R+Mₓ+R⁻¹) (in Z_{N})

Steps 150 and 155: If β=1 or T<8·γ (in Z), set U,W ←0 and go directly to step 210.

Step 160: Set D←α⁻¹ (in Z_{β}, not in Z_{N}; i.e., α·D−1 in Z_{β})

Step 170: Set A←N/β (in Z; i.e., integer division with truncation)

Step 180: Set B←(T−8·γ)/A (in Z; i.e., integer division with truncation)

Step 190: Set U←·D (in Z_{β}, not in Z_{N})

Step 200: Set W←U·R (in Z_{N})

Step 210: Set C←(T−W)/γ (in Z; i.e., integer division with truncation)

Step 220: Set z←U+β·C (in Z_{N})

Step 230: Set x←T−z·R (in Z_{N})

Step 240: Set y←S·(x+Mₓ+2·R⁻¹) (in Z_{N})

The method of FIGS. 2A and 2B is now briefly described. A proof of correctness of the method of FIGS. 2A and 2B is provided below.

The general form of a solution to the Fuzzy OSS equation (ignoring, for the moment, the inequalities that must also be satisfied for x and z), is:

(M_{X}+x)=±(R⁻¹+(M_{Z}+z)·R) and y=±S·(R^{31 1}−(M_{Z}+z)·R)

If we arbitrarily choose the “−” in the ±, and set T equal to a common subexpression:

T=−(M_{Z}·R+M_{X}+R⁻¹)

then steps 140, 230, and 240 follow immediately.

In other words, it is simply a matter of algebraic manipulation to find x, y, and z that satisfy the Fuzzy OSS equation; such x, y, and z will not necessarily satisfy the required additional inequalities. Steps 140, 230, and 240 guarantee that the equation is satisfied for any arbitrarily chosen R and z. The purpose of the other steps is to guarantee that the inequalities will also be satisfied. More specifically:

Steps 110-130 have the purpose of choosing an R such that for any M_{X} and M_{Z} it will be possible to find a z such that not only the Fuzzy OSS equation, but also the inequalities on x and z, are satisfied.

Given that choice of R, steps 150-220 have the purpose of choosing such a z.

The following is intended to be an intuitive, informal argument of why the method of FIGS. 2A and 2B works; a formal proof is provided below. In this informal description, we will use terms like “small” (and “close”) to denote values (and differences of values) that are much smaller than the modulus N. By this convention, for example, x and z would be considered “small”, although they are usually very large numbers.

Regarding the choice of R (steps 110-130), note that eventually z·R=T−x in Z_{N} (by step 230). Since x and z both are required to be “small”, this is really equivalent to saying that R should be chosen such that for any resultant T, it is possible to find a “small” z such that z·R is “close” to, but less than, T. This can be done, as described below with reference to steps 150-220, when R is chosen according to steps 110-130.

Now, given that choice of R, we need to find “small” z such that z·R mod N is “close” to T (since x=T−z·R mod N must be small). This is actually done in two stages:

Steps 160-190 compute a “coarse estimate” U of z, actually aiming to find a value U such that U·R ≅T−8·γ mod N, i.e., actually slightly less than T.

Steps 200-220 compute an error term (T−U·R) mod N, and from that term derive a “fine correction” β·C to be added to the coarse estimate U in order to produce the actual z value.

In steps 150 and 155, T is checked to see if it is “small”. If the T is “small”, then the coarse estimate U for z is taken as zero, steps 160-200 may be skipped, and the fine correction becomes the fall value of z.

The efficiency of the method of FIGS. 2A and 2B will be analyzed below. In the analysis, it will be noted than an even much more efficient solution than the method of FIGS. 2A and 2B exists based on β=1 or at least β “small”. However, there is some question whether the method thus restricted is as secure, since it generates solutions with far less generality, within the entire solution space, than the above method.

A proof of correctness of the method of FIGS. 2A and 2B is now offered as follows.

The following is asserted to be true:

(Mₓ+x)²−V·y²=4·(M_{z}+z) in Z_{N} [A1]

0≦x<2^{n-k} [A2]

0≦z<2^{k+3} [A3]

The items asserted to be true are also termed herein “assertions”.

The following simple lemmas concerning properties of integer division, with truncation as necessary, are presented without proof. All variables are positive integers:

0≦(x·y)/z−x·(y/z)<x [L1]

0≦(x+y)/z−(x/z+y/z)≦1 [L2]

x<z [symbol] (x·y)/z<y [L3]

w≡x(mod z) [symbol] (w·y)/z≡(x·y)/z(mod y) [L4]

y<x [symbol] x/(x/y)<2·y [L5]

(((x·y)/z)/y)·z<x [L6]

The following lemma concerning the relationship between W and T is now presented with proof; the lemma will be need needed for the proofs of assertions [A2] and [A3] above:

W≦T, and either β=1 or (T−W)<(15·2^{k-1}·γ)/β [L7]

Proof:

Note: In this proof, and in the proofs of the assertions mentioned above that follow, when evaluating variables such as W, x, or z that are evaluated modulo N, in the interest of simplifying the notation, any multiples of N that implicitly appear are dropped additively at the highest level of the equality, rather than carrying them through and dropping them at the end. Note especially the point concerning dropping at the highest level: If x=y+N·z, x=y may be written, but it is not valid to write x=y/w in place of x=(y+N·z)/w].

If β is chosen to be 1, then W is set to 0 (steps 150 and 155 of the method of FIGS. 2A and 2B), so the result immediately follows.

Likewise, if (at step 150 of the method) T<8·γ, then W is set to 0, and again the result follows almost immediately, since β<2^{k-1}.

Otherwise:

$$\begin{matrix}W = U \cdot R & \text{\{Step 200\}} \\ = U \cdot ( ( α \cdot N + γ ) / β ) & \text{\{Step 130\}} \\ = ( U \cdot ( α \cdot N + γ ) ) / β - {ϵ}_{1} & \{ 0 \leq {ϵ}_{1} < U ; Lemma [ L1 ] \} \\ = ( U \cdot α \cdot N + U \cdot γ ) / β - {ϵ}_{1} & \\ = ( U \cdot α \cdot N ) / β + ( U \cdot γ ) / β - {ϵ}_{1} + {ϵ}_{2} & \{ 0 \leq {ϵ}_{2} \leq 1 ; Lemma [ L2 ] \} \\ = ( U \cdot α \cdot N ) / β - {ϵ}_{1} + {ϵ}_{2} + {ϵ}_{3} & \{ 0 \leq {ϵ}_{3} < γ ; Lemma [ L3 ] \} \\ = ( B \cdot D \cdot α \cdot N ) / β - {ϵ}_{1} + {ϵ}_{2} + {ϵ}_{3} & \text{\{Step 190;} Lemma [ L4 ] \text{\}} \\ = ( B \cdot N ) / β - {ϵ}_{1} + {ϵ}_{2} + {ϵ}_{3} & \text{\{Step 160;} Lemma [ L4 ] \text{\}} \\ = B \cdot ( N / β ) - {ϵ}_{1} + {ϵ}_{2} + {ϵ}_{3} + {ϵ}_{4} & \{ 0 \leq {ϵ}_{4} < B ; Lemma [ L1 ] \} \\ = B \cdot A - {ϵ}_{1} + {ϵ}_{2} + {ϵ}_{3} + {ϵ}_{4} & \text{\{Step 170\}} \\ = ( ( T - 8 \cdot γ ) / A ) \cdot A - {ϵ}_{1} + {ϵ}_{2} + {ϵ}_{3} + {ϵ}_{4} & \text{\{Step 180\}} \\ = ( T - 8 \cdot γ ) - {ϵ}_{1} + {ϵ}_{2} + {ϵ}_{3} + {ϵ}_{4} - {ϵ}_{5} & \{ 0 \leq {ϵ}_{5} < A ; Lemma [ L1 ] \}\end{matrix}$$

So T−W=8·γ+ε₁+ε₅−ε₂−ε₃−ε₄. Since all of the εᵢ are non-negative, we will have proved our lemma if we can show that:

ε₂ε₃ε₄≦8·65, [a]

and

8·γ+ε₁+ε₅<(15·2^{k-1}·γ)/β [b]

Proof of [a]:

$$\begin{matrix}B = ( T - 8 \cdot γ ) / A & \text{\{Step 180\}} \\ < N / A & \\ = N / ( N / β ) & \text{\{Step 170\}} \\ < 2 \cdot β & \{ Lemma [ L5 ] \} \\ < 2 \cdot γ & \end{matrix}$$

So ε₂+ε₃+ε₄<1+γ+B≦8·γ

Proof of [b]:

$$\begin{matrix}A = N / β & \text{\{Step 170\}} \\ < {2}^{n} / β & \\ = ( 4 \cdot {2}^{k - 1} \cdot {2}^{n - k - 1} ) / β & \\ \leq ( 4 \cdot {2}^{k - 1} \cdot γ ) / β & \end{matrix}$$

Also, U<β<γ, and β<2^{k-1} (and thus x≦(x·2^{k-1})/β for any x)

So 8·γ+ε₁+ε₅<8·γ+U+A<(15·2^{k-1}·γ)/β

Proof of assertions [A1], [A2], and [A3], using lemma [L7] where necessary:

(Mₓ+x)²−V·y²=4·(M_{z}+z) in Z_{N} [A1]

Proof:

$$\begin{matrix}{( {M}_{x} + x )}^{2} - V \cdot {y}^{2} = {( {M}_{x} + T - z \cdot R )}^{2} - V \cdot {S}^{2} \cdot {( x + {M}_{x} + 2 \cdot {R}^{- 1} )}^{2} \\ = {( ( {M}_{z} + z ) \cdot R + {R}^{- 1} )}^{2} - {( T - z \cdot R + {M}_{x} + 2 \cdot {R}^{- 1} )}^{2} \\ = {( ( {M}_{z} + z ) \cdot R + {R}^{- 1} )}^{2} - {( ( {M}_{Z} + z ) \cdot R - {R}^{- 1} )}^{2} \\ = 4 \cdot ( {M}_{z} + z )\end{matrix}$$

0≦x<2^{n-k} [A2]

Proof:

$$\begin{matrix}x = T - z \cdot R & \text{\{Step 230\}} \\ = T - ( U + β \cdot C ) \cdot R & \text{\{Step 220\}} \\ = ( T - U \cdot R ) - ( β \cdot R ) \cdot C & \\ = ( T - W ) - γ \cdot C & \text{\{Step 130\}} \\ = ( T - W ) - γ \cdot ( ( T - W ) / γ ) & \text{\{Step 210\}} \\ < γ & \{ Lemmas [ L1 ] , [ L7 ] \} \\ < {2}^{n - k} & \end{matrix}$$

0≦z<2^{k+3} [A3]

Proof:

If β=0, then U=W=0, so:

$$\begin{matrix}z = U + β \cdot C & \text{\{Step 220\}} \\ = C & \\ = ( T - W ) / γ & \text{\{Step 210\}} \\ = T / γ & \\ < N / {2}^{n - k - 1} & \\ < {2}^{k + 3} & \end{matrix}$$

Otherwise, by Lemma [L7], (T−W)<(15·γ·2^{k-1})/β, so:

$$\begin{matrix}z = U + β \cdot C & \text{\{Step 220\}} \\ = U + ( ( T - W ) / γ ) \cdot β & \text{\{Step 210\}} \\ < β + ( ( T - W ) / γ ) \cdot β & \text{\{Step 190\}} \\ < β + ( ( ( 15 \cdot γ \cdot {2}^{k - 1} ) / β ) / γ ) \cdot β & \{ Lemma [ L7 ] \} \\ < β + 15 \cdot {2}^{k - 1} & \{ Lemma [ L6 ] \} \\ < 16 \cdot {2}^{k - 1} & \\ = {2}^{k + 3} & \end{matrix}$$

The efficiency of the method of FIGS. 2A and 2B is now analyzed.

As will be appreciated by persons skilled in the art, there are a limited number of multiple precision multiplicative operations involved in the method of FIGS. 2A and 2B, although more than in the original OSS. Some of the operations are multiplications and some are divisions. Among the divisions, some are in Z (division in Z is comparable in efficiency to multiplication) and some are in a finite ring Z_{N} or Z_{β} (division in a finite ring is more time-consuming than multiplication).

Here are some other observations concerning the efficiency, referring to the steps of FIGS. 2A and 2B:

Step 150 costs very little Oust a multiplication by a very small constant).

Steps 120 and 130 can essentially be combined, since γ and R can be found in a combined process in which γ is chosen arbitrarily, α·N+γ is divided by β to obtain the quotient (R) and the remainder, the latter being used to refine the choice of γ so that α·N+γ is divisible by β.

Steps 110 and 160 can be combined, since the gcd method can also yield the inverse.

R⁻¹ does not need to be evaluated for step 240, since it was already evaluated for step 140.

Since the modulus N is public, the inverting of R with respect to N may be delegated to a more powerful non-secure processor (if available) by “blinding” the R with a random multiplicative factor in Z_{N} (Naccache also notes this; see reference [4]).

Blinding involves performing some transform on secret data before exposing it, in a way that the transform hides the original value(s). In the case of taking the inverse of a non-zero value x in the field Z_{P} (P prime), the value x may be blinded by multiplying it by an arbitrary non-zero r in Z_{P}:

y←r·x(in Z_{P})

Now since y can have, with equal probability, any value in Z_{P}, it does not need to be kept secret; revealing y can not possibly reveal anything about x (which is secret). Any “non-trusted” computer may be asked to invert y in Z_{P}:

z←y⁻¹(in Z_{P})

The inverse of the original x in Z_{P} may then be recovered by multiplication:

x⁻¹←r·z(in Z_{P})

This last step is sometimes called unblinding, that is, an inverse operation that undoes the original blinding.

Note that the “non-trusted” computer may be non-trusted in two senses:

Not to be trusted with the secret value of x.

Not to be trusted to compute the inverse correctly (it may be possible to perform some sort of “fault attack” by supplying an incorrect inverse, and seeing the eventual result). A “fault attack” is an attack in which one of the protocol partners or some external observer intentionally introduces an error into the protocol to observe the processing on the faulty data, hoping thereby to gain some information. Such an attack attempts to take advantage of the fact that some otherwise secure protocols are not robust enough to avoid leaking secrets when handling non-valid data such as, for example, out of range data.

To protect against the first point of non-trust, blinding is preferably used, as described above. To protect against the second point of non-trust, the secret computer (the one that did the blinding and unblinding) should check the result before proceeding:

x·x⁻¹=?1(in Z_{P})

Note that we assumed P is prime, which is necessary to achieve absolute blinding. If P is not prime, then if y is not relatively prime to P, this will not work. However, since RSA-type moduli are the product of two extremely large primes, the chance of any “randomly” chosen number (or the product of two such numbers) not being relatively prime to the modulus is infinitesimally small, and the blinding may be treated as absolute for all practical purposes.

The advantage of blinding, in our context, is that for “infinite precision” (large number of digits) numbers, modular division and modular inversion (while tractable, unlike modular root extraction) are considerably more time-consuming than modular multiplication. If the secure computer is relatively weak (for example, a smart card), then given the availability of a powerful but non-secure computer to perform the blinded inversion, it may be more efficient to perform all of the following:

Three modular multiplications (blinding, unblinding, and confirmation) in the secure computer.

A modular inversion in the non-secure computer.

A data transfer in each direction. than to perform a single inversion in the secure computer.

The expected number of retries in step 110 until α and β are chosen to be relatively prime is small, since for any randomly chosen pair (α, β) of integers, the probability P of their having a common factor greater 1 satisfies:

$$\begin{matrix}P < 1 / {2}^{2} + 1 / {3}^{2} + 1 / {5}^{2} + 1 / {7}^{2} + 1 / {11}^{2} + … \\ = ( 1 + 1 / {2}^{2} + 1 / {3}^{2} + 1 / {4}^{2} + 1 / {5}^{2} + … ) - \\ ( 1 + 1 / {4}^{2} + 1 / {6}^{2} + 1 / {8}^{2} + 1 / {9}^{2} + … ) \\ = {π}^{2} / 6 - ( 1 + 1 / {4}^{2} + 1 / {6}^{2} + 1 / {8}^{2} + 1 / {9}^{2} + … )\end{matrix}$$

From evaluating a small number of terms, it can be seen that P<0.5, so the expected number of retries is less than 1.

Another way of stating the above result is to say that the expected value of Φ(β)/β, where Φ( ) is the Euler totient function and β is chosen randomly from some large range of integers, is slightly greater than 0.5. We will also make use of this fact in the following section when discussing the security of the method.

The task of choosing α and β until a relatively prime pair is found may be additionally sped up by pre-screening with a very quick test that yields a small number of false positives. Randomly choose a pair (α, β, and then evaluate:

gcd(210,(αmod 210), βmod 210))

If the value of the evaluated expression is equal to 1, then α and β have no common factor of 2, 3, 5, or 7, and they are with high probability relatively prime. (At this point it is necessary to perform the real gcd of α and β to eliminate any false positives, and this will also yield the inverse of α in Z_{β}, as noted above.) The remainder (modulo) of any number with respect to 210 can be evaluated very quickly on almost any processor, since 210 fits in a single byte.

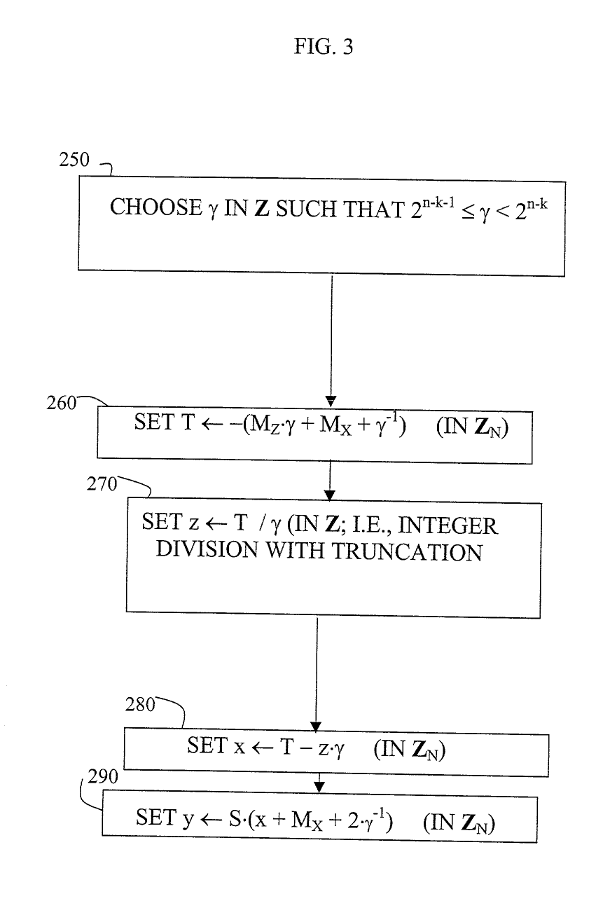

Reference is now additionally made to FIG. 3, which is a simplified flowchart illustration of an alternative preferred implementation of step 100 of FIG. 1. In the preferred embodiment of FIG. 3, as compared to the preferred embodiment of FIGS. 2A and 2B, a number of steps of FIGS. 2A and 2B, those between 160 and 200 inclusive, may be eliminated altogether by choosing (α, β)=(0, 1). The method of FIG. 3 is also termed herein “the restricted method”.

When β is chosen to be 1, the restricted method reduces to the following steps:

Step 250: Choose γ such that 2^{n-k-1}≦γ<2^{n-k}

Step 260: Set T←−(M_{z}·γ+Mₓ+γ⁻¹) (in Z_{N})

Step 270: Set z←T/γ (in Z; i.e., integer division with truncation)

Step 290: Set x←T−z·y (in Z_{N})

Step 300: Set y←S·(x+Mₓ+2·γ⁻¹) (in Z_{N})

Even if β is not chosen to be 1, it will be appreciated that a large number of steps of the method of FIGS. 2A and 2B (110-130, 160-200, and 220) are monotonically related in efficiency to the size of β, so they will be very efficient if β is much smaller than the modulus. Only steps 140, 210, 230, and 240 remain costly independent of the size of β. In the following discussion, however, speculation is raised on the possible security impact of choosing β=1 or β small.

The security of the method of FIGS. 1, 2A, and 2B is now discussed.

Attacks on proposed signature schemes typically take one of two forms:

1. A tractable method for signing even without knowledge of the private key.

2. A method for uncovering the private key, or at least information that allows signing, from information leaked in a set of solutions generated with the private key method.

The two attack possibilities are now considered in turn.

The original OSS fell to an attack of the first kind. It is difficult to speculate whether or not this attack could be extended to the Fuzzy OSS problem. Note, however, that in the extreme case where k is allowed to approach 0, the Fuzzy OSS problem converges to the original problem. Thus it seems more likely that any attack along these lines would incorporate the original OSS attack in some way, possibly in conjunction with some lattice methods, rather than being entirely independent of it. Alternatively, perhaps such an attack would involve a transformation of any Fuzzy OSS problem to an original OSS problem.

In general, the second kind of attack described above can be avoided when:

An arbitrary number of problems and corresponding solutions can be generated for any public key, assuming freedom over the choice of the message digest, in this case (Mₓ, M_{z}); and

there is exactly, or very nearly, a one-to-one correspondence between the random parameters, and the solutions generated therewith according to the private key method, on the one hand, and the entire solution space on the other hand, as is the case with the original OSS.

The first of the two conditions above clearly holds with the Fuzzy OSS problem, as can be easily seen from the Fuzzy OSS equation. Regarding the second item, when there is considerable loss of generality such as, for example, when the private key method generates only a fraction of the total solution space or generates certain solutions with significantly higher probability than others, some information is leaked. The ability to utilize that leaked information for a full attack can be highly dependent upon the structure of the private key method and that of the missing generality. It will be shown below that, for the Fuzzy OSS problem and the private key method presented herein, the solution space of the private key method is only “slightly” less general than the total solution space, by a factor of 2^{j} for some very small j. There will be no attempt to analyze here whether it is possible to exploit that lack of generality.

First note that if (x, z) is chosen randomly (there are 2ⁿ⁺³ such random choices, according to the restrictions on the size of x and z), then there is, with probability ¼, a total of four y values for which (x, y, z) is a solution, and with probability ¾, no such y values. Thus the total true solution space (as opposed to the solution space generated by our private key method) has a size of approximately 2ⁿ⁺³.

Now consider the set of all solutions generated by the private key method presented in the present specification. First consider the set of all valid (α, β, γ) that may be chosen according to the restrictions given, referring to the above description of the method of FIG. 1 and FIGS. 2A and 2B. Note that for a given choice of β there are Φ(β) possible choices of α, where Φ( ) is the Euler totient function, and for each (α, β) an average of 2^{n-k-1}/β (here we are dealing with real numbers rather than integers) possible choices of γ. This means that for each β that may be chosen, there are approximately 2^{n-k-1}·Φ(β)/β possible choices of (α, γ). Since there are 2^{k-1} possible choices of β, and it has been shown above that the expected value of Φ(β)/β is slightly greater than 0.5, the total number of possible choices of (α, β, γ) is approximately (actually slightly greater than) 2ⁿ⁻³.

Next, it will be shown that there is a one-to-one correspondence between choice triples (α, β, γ) and solution triples (x, y, z). It is clear from the method description that each such choice triple yields a single solution triple, since the method is deterministic from after the point of selection of the choice triple, but it also needs to be shown that distinct choice triples yield distinct solution triples. First note that:

R=2·(y·S⁻¹−x−Mₓ)⁻¹ in Z_{N}

so each solution triple is associated with a single R; we then need to show only that each R is associated with a single choice triple.

Suppose two choice triples (α₁, β₁, γ₁) and (α₂, β₂, γ₂) yield the same R. This means that:

(α₁·N+γ₁)/β₁=(α₂·N+γ₂)/β₂

or equivalently:

(α₁·β₂)·N+(γ₁·β₂)=(α₂·β₁)·N+(γ₂·β₁)

Since:

0<β₁,β₂<2^{k-1} and 0<γ₁,γ₂<2^{n-k} and 2ⁿ⁻¹≦N

it follows that:

0<γ₁·β₂<N and 0<γ₂·β₁<N

and so:

α₁·β₂=α₂·β₁ and γ₁·β₂=γ₂·β₁

Since:

β₂|(α₂·β₁) and gcd(β₂,α₂)=1

therefore:

β₂|β₁

(and likewise β₁|β₂ by an analogous argument)

Thus:

(α₁,β₁,γ₁)=(α₂,β₂,γ₂)

Thus, it has been shown that there is a one-to-one correspondence between choice triples and values of R, and together with the earlier argument, shown that there is a one-to-one correspondence between solution triples of the private key method and choice triples. Since there are approximately 2ⁿ⁻³ choice triples, as described above, as opposed to 2ⁿ⁺³ solution triples, approximately 6 bits of generality are lost by the private key method. It is actually possible to tighten this slightly so that slightly fewer bits of generality are lost, but both the method and its proof become messier, and occasionally retries are necessary. The details are omitted here.

As a final point, it was noted above that the efficiency of the method may be improved by choosing (α, β)=(0, 1), as in the method of FIG. 3, or at least choosing β to be “small”. However, when β is chosen to be much smaller than 2^{k-1}, this significantly reduces the generality of the solution, that is, the ratio of solutions produced by the method to the true total number of solutions, and may impact the security. If k is chosen to be relatively small compared to n, the modulus size, but still significantly greater than 0, for example, n=1024, k=128, then a β of approximately k bits may be chosen without losing generality of the solution. This is because the greater freedom of γ, approximately n−k bits, offsets the loss of generality in β. This appears to be a way to improve performance, by working with a relatively small β, without sacrificing the generality of the solution. However, note that the signature size is (2·n−k) bits, since it does not need to explicitly include z, as we noted earlier, and therefore reducing k for a fixed n increases the signature size.

Summarizing the above points:

Assuming freedom in the choice of the message digest, an arbitrary number of problems and their corresponding solutions can be generated for any public key. Therefore, a private key method that covered the true total solution space with perfect generality and uniformity would leak no information.

The presented private key method does not completely cover the true total solution space, but it comes within several bits of doing so. Moreover, the coverage, although not totally general, is uniform, that is, there is one-to-one correspondence between choice parameters and generated solutions.

There is no obvious way to exploit the indicated small lack of generality in order to learn how to sign from seeing a number of signatures, because of the complex, non-linear, in fact, non-polynomial, relationship between the choice parameters and the solutions.

The more promising attack approach would seem to be trying to find a way to solve the equation without any knowledge of the private key (as with the original OSS attack). Such an approach would be at least as difficult as the original OSS attack, since Fuzzy OSS converges to OSS as k→0. The attack might consist of a way of performing a polynomial-time transformation of a Fuzzy OSS problem to an OSS problem.

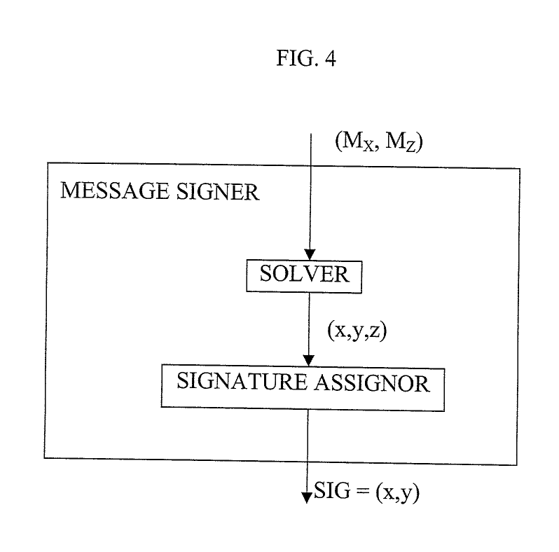

Without limiting the generality of the present invention, it is appreciated that the present invention may be implemented in software on any appropriate hardware platform, and may also be implemented, for example, in firmware or in appropriate special-purpose hardware. Reference is now made to FIG. 4, which is a simplified block diagram illustration of an apparatus suitable for implementing the method of FIG. 1. The apparatus of FIG. 4 is self-explanatory.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

What is claimed is:

1. A method for digitally signing a message, the method comprising:
providing a message digest (M_{X}, M_{Z});
providing a modulus N;
providing a number V in the ring Z_{N}, wherein for another number S in the ring Z_{N}, V·S²=1 in Z_{N};
solving the equation (Mₓ+x)²−V·y²=4·(M_{z}+z) in Z_{N} to produce x, y, and z; and
assigning SIG as the signature of (M_{X}, M_{Z}), wherein SIG comprises (x,y).

2. The method according to claim 1 and wherein SIG comprises (x,y,z).

3. The method according to claim 1 and wherein the solving comprises the following:
a) choosing α and β in Z such that 0≦α<β<2^{k-1} and gcd(α,β)=1 in Z;
b) choosing γ in Z such that 2^{n-k-1}≦γ<2^{n-k} and β|(α·N+γ) in Z;
c) setting R equal to (α·N+γ)/β in Z;
d) setting T equal to −(M_{z}·R+MₓR⁻¹) in Z_{N};
e) if β=1 or T<8·γ (in Z), setting U and W equal to 0 and continuing with step k;
f) setting D equal α⁻¹ in Z_{β};
g) setting A equal to N/β in Z;
h) setting B equal to (T−8·γ)/A in Z;
i) setting U equal to B·D in Z_{β};
j) setting W equal to U·R in Z_{N};
k) setting C (T−W)/γ in Z;
l) setting z equal to U+β·C in Z_{N};
m) setting x equal to T−z·R in Z_{N}; and
n) setting y equal to S·(x+Mₓ+2·R⁻¹) in Z_{N}, thereby producing x, y, and z.

4. The method according to claim 3 and also comprising:
providing a trusted computation device and a non-trusted computation device,
wherein step d) comprises performing a computation in the non-trusted computation device.

5. The method according to claim 4 and wherein the computation in the non-trusted computation device comprises a computation of R⁻¹.

6. The method according to claim 5 and wherein the computation in the non-trusted computation device is protected from tampering by performing a blinding method in the trusted computation device.

7. The method according to claim 6 and also comprising verifying a result of the computation in the non-trusted computation device.

8. The method according to claim 3 and wherein step a) comprises screening α and β.

9. The method according to claim 8 and wherein the screening comprises reducing α and β modulo 210.

10. The method according to claim 9 and wherein the reducing a and β modulo 210 comprises:
computing gcd(210, (α mod 210), (β mod 210)) to produce a result; and
rejecting α and β and choosing another α and β if the result is not equal to 1.

11. The method according to claim 1 and wherein the solving comprises the following:
a) setting α equal to 0;
b) setting β=1;
c) choosing γ such that 2^{n-k-1}≦γ<2^{n-k};
d) setting T equal to −(M_{z}·γ+Mₓ+γ⁻¹) in Z_{N};
e) setting z equal to T/γ in Z;
f) setting x equal to T−z·γ in Z_{N}; and
g) setting y equal to S·(x+Mₓ+2·γ⁻¹) in Z_{N},
thereby producing x, y, and z.

12. The method according to claim 11 and also comprising:
providing a trusted computation device and a non-trusted computation device,
wherein step d) comprises performing a computation in the non-trusted computation device.

13. The method according to claim 12 and wherein the computation in the non-trusted computation device comprises a computation of γ⁻¹.

14. The method according to claim 13 and wherein the computation in the non-trusted computation device is protected from tampering by performing a blinding method in the trusted computation device.

15. The method according to claim 14 and also comprising verifying a result of the computation in the non-trusted computation device.

16. A message signer for digitally signing a message based on a message digest (M_{X}, M_{Z}), a modulus N, and a number V in the ring Z_{N}, wherein for another number S in the ring Z_{N}, V·S²=1 in Z_{N}, the message signer comprising:
a solver for solving the equation (Mₓ+x)²−V·y²=4·(M_{z}+z) in Z_{N} to produce x, y, and z; and
a signature assignor for assigning SIG as the signature of (M_{X}, M_{Z}), wherein SIG comprises (x,y).
